(19) United States
(12) Patent Application Publication
(10) Pub. No.: US 2013/0271415 A1
(43) Pub. Date: Oct. 17, 2013

(54) MECHANISM FOR EMPLOYING AND FACILITATING A TOUCH PANEL THUMB SENSOR PAD AT A COMPUTING DEVICE

(71) Applicant: David L. Graumann, Portland, OR (US)

(72) Inventor: David L. Graumann, Portland, OR (US)

(73) Assignee: Intel Corporation, Santa Clara, CA (US)

(21) Appl. No.: 13/977,395

(22) PCT Filed: Sep. 30, 2011
(86) PCT No.: PCT/US11/54427

§ 371 Date: Jun. 28, 2013

(51) Int. Cl. G06F 3/041

(52) U.S. Cl. CPC G06F 3/041
USPC 345/173

(57) ABSTRACT

A mechanism is described for employing and facilitating a sensor pad transparently placed at a touch panel of a computing device. A method of embodiments of the invention includes sensing a use of a sensor pad transparently placed over and within a dedicated section of a touch panel of a computing device. The sensor pad and its relevant sensor pad interaction may be employed using hardware of the touch panel, the use including touching of the sensor pad by a user, while sensing may include detecting a change at one or more intersecting points of a plurality of intersecting points. The method may further include facilitating an action in response to the use of the sensor pad.

### FIELD

The field relates generally to computing devices and, more particularly, to employing a mechanism for employing and facilitating a touch panel thumb sensor pad at a computing device.

### BACKGROUND

With the increase in the use of mobile device, it is getting increasingly important to make these devices easy to use (e.g., using touch panels) but without having to increase the cost, size or complexity and/or reduce value, efficiency or existing features. None of the current technologies satisfy the aforementioned standards. For example, one way to increase touch panel sensitivity or functionality is to add a number of extra components to the device (e.g., a microcontroller, Central Processing Unit (CPU) drivers, cables or connectors, etc.) which results in increased cost, size, complexity, etc.

### BRIEF DESCRIPTION OF THE DRAWINGS

Embodiments of the present invention are illustrated by way of example and not by way of limitation in the figures of the accompanying drawings, in which like references indicate similar elements and in which:

FIG. 1 illustrates a computing device employing and facilitating a touch panel thumb sensor pad mechanism according to one embodiment of the invention;

FIG. 2 illustrates a touch panel thumb pad mechanism employed at a computing device according to one embodiment of the invention;

FIGS. 3A-3C illustrate a computing device employing and facilitating a thumb pad using a touch panel thumb pad mechanism according to one embodiment of the invention;

FIG. 4 illustrates a method for employing and facilitating a thumb pad using a touch panel thumb pad mechanism according to one embodiment of the invention; and

FIG. 5 illustrates a computing system according to one embodiment of the invention.

### DETAILED DESCRIPTION

Embodiments of the invention provide a mechanism for employing and facilitating a sensor pad transparently placed at a touch panel of a computing device. A method of embodiments of the invention includes sensing a use of a sensor pad transparently placed over and within a dedicated section of a touch panel of a computing device. The sensor pad and its relevant sensor pad interaction may be employed using hardware of the touch panel, the use including touching of the sensor pad by a user, while sensing may include detecting a change at one or more intersecting points of a plurality of intersecting points. The method may further include facilitating an action in response to the use of the sensor pad.

In one embodiment, a computing device (e.g., a mobile computing device, such as a smartphone) can be controlled using a thumb pad provided at a corner (e.g., a top right-hand corner) of a touch panel. This way, the computing device may be controlled without placing a finger or thumb in front of the displayed content (that is being viewed by the user using the display screen of the computing device). Embodiments of the invention provide a novel approach of using an edge or corner of the touch panel to keep the various factors (e.g., cost, size, manufacturing complexity, etc.) low or at least compatible with those of today's conventional computing devices.

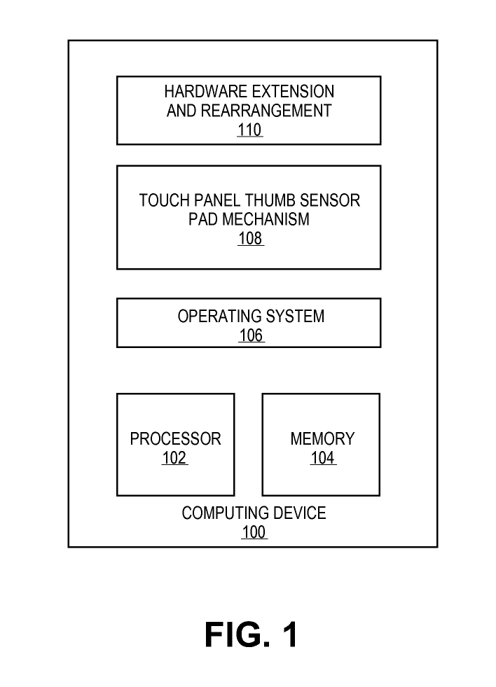

FIG. 1 illustrates a computing device employing and facilitating a touch panel thumb sensor pad mechanism according to one embodiment of the invention. In one embodiment, a computing device 100 is illustrated as having a touch panel (TP) thumb sensor pad mechanism 108 (“TP thumb pad mechanism”) to employ and facilitate a TP thumb pad. Computing device 100 includes a mobile computing device, such as a smartphone (e.g., iPhone®, BlackBerry®, etc.), a handheld computing device, a personal digital assistant (PDA), a tablet computer (e.g., iPad®, Samsung® Galaxy Tab®, etc.), a laptop computer (e.g., notebooks, netbooks, etc.), and other similar mobile computing devices, etc., having a touchscreen or touch panel having a virtual keyboard, etc., serving as a source of input. Computing device 100 further includes an operating system 106 serving as an interface between any hardware or physical resources of the computer device 100 and a user. Computing device 100 may further include a processor 102, memory devices 104, network devices, drivers, or the like. It is to be noted that terms like “machine”, “device”, “computing device”, “computer”, “computing system”, and the like, are used interchangeably and synonymously throughout this document.

In one embodiment, the computing device 100 further includes a hardware extension 110 that is used to provide the necessary hardware and/or circuitry to employ and adopt a thumb pad; for example, in one embodiment, a portion (e.g., a triangular shaped space at the top right corner of the touch panel) of the touch panel of the computing device 100 may be reduced to provide a thumb pad using the hardware extension 110 as will be further described with reference to the subsequent figures.

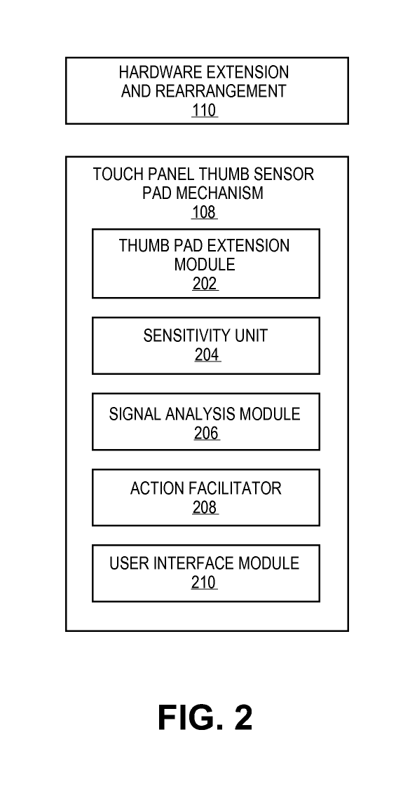

FIG. 2 illustrates a TP thumb pad mechanism employed at a computing device according to one embodiment of the invention. In one embodiment, TP thumb pad mechanism 108 includes various components 202-208 to facilitate the use of a thumb sensor as described throughout this document. In one embodiment, the TP thumb pad mechanism 108 includes a thumb pad extension module 202 (“extension module”) to work with hardware extension and rearrangement 110 to work with the touch panel and its hardware circuitry to provide a thumb pad. For example, various hardware components of the touch panel and of the computing device, in general, to provide the thumb pad without having to further complicate the existing hardware of the computing device. For example and in one embodiment, a TP thumb pad of any shape (e.g., triangular-shaped) is placed in a corner of the computing device's display or touch pad/panel corner that does not typically require touch interaction by the user, such as the top right-hand corner of a touch pad that is not typically touched or used by the user. Further and in one embodiment, to accommodate TP thumb pad, various hardware components may be removed or rearranged, such as various radio strength indicators, application status indicators, and the like, so that the particular corner or area can be freed up to employ and accommodate the TP thumb pad. In another embodiment, a number of not-so-important and/or not-so-frequently-used components may be placed in the corner or area that is occupied by the TP thumb pad. Similarly, any existing icons or hyperlinks, etc., may be moved from under the potential thumb pad to another area of the touch panel or screen so that they can be seen visually but prevented from being activated by accidental touches to the thumb pad, while other readable content and ambient status icons may continue to remain under the thumb pad.

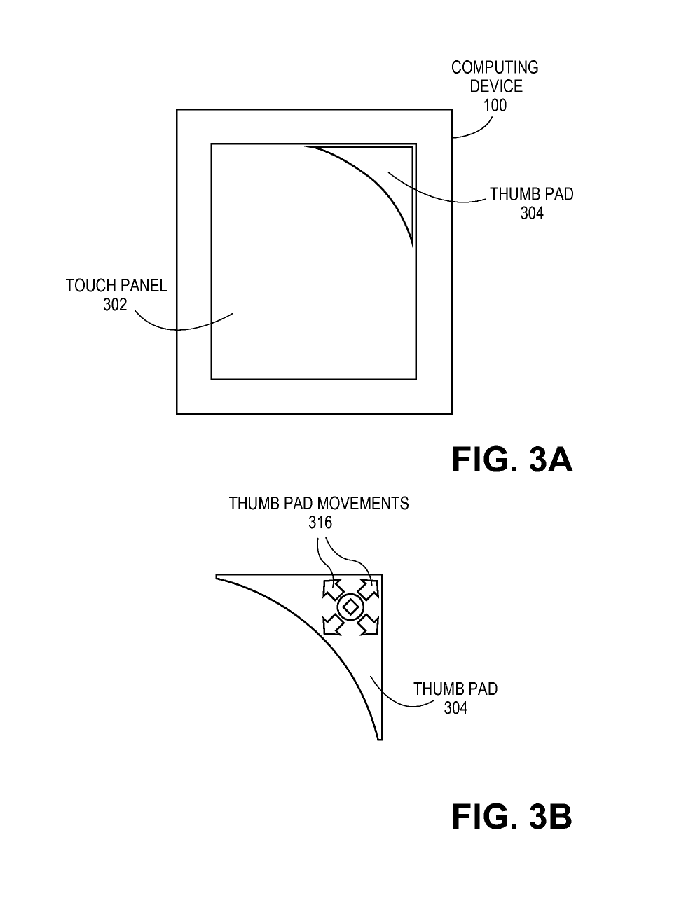

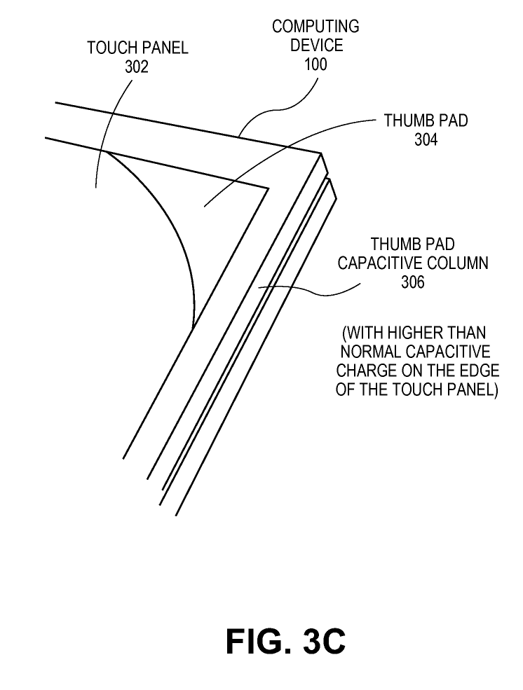

The extension module 202 may be further used to reduce the amount of hardware needed to employ the thumb pad on one side (e.g., top left side) of the touch panel of the computing device. For example, the extension module 202 may provide overlaying hardware (e.g., virtual scroll and flick area) over a corner of (and/or along the right and/or left edge) the touch panel such that the overlaying hardware is in communication with the rest of the touch panel through common conductive lines and other hardware components. In other words, in one embodiment, rather than having an entire touch panel maintain a 1-to-2-to-1 mapping to display pixels, the triangular (or another shape) region at corner (e.g., top right corner) of the touch panel acts as the mouse pad or trackball equivalent. The user may move up/down/left/right and flick or brush to navigate the thumb pad user interface provided by the user interface module 210. The design and interactions of the thumb pad may be matched with the thumb arc and potential movement. This will be illustrated and further discussed with reference to FIGS. 3A-3C.

In one embodiment, a sensitivity module unit 204 is employed to sense the user touch to the thumb pad and the sensitivity resulting from the touch. The sensitivity unit 204 can sense the sensitivity and the signal that contained within that sensitivity and provides the sensitivity data to a signal analysis module 206 provided by the TP thumb pad mechanism 108. The signal analysis module 206 analyzes the sensitivity data to interpret the signal contained within the sensitivity obtained from the user touch of the thumb pad. For example, the sensitivity data my reveal whether the user may have brushed, flicked, or pressed the thumb pad which can then be made a basis for determining the type of action intended or anticipated by the user, such as pressed the thumb pad to obtain additional information relating to an open contact or website, etc., or flicked in a certain way to scroll up or down the current page being displayed on the display screen of the computing device, and the like.

The signal analysis or interpretation is then sent on to an action facilitator 208 to facilitate any action requested by the user through the thumb sensor. For example, if the user wishes to scroll down or up the screen using the thumb sensor, the action facilitator 208, working with other components 202-206, 210, ensures that the screen is scrolled up or down as requested by the user. It is contemplated, as aforementioned, the TP thumb pad mechanism 108 works with the hardware extension 110 to, for example, provide common conductive lines between the touch panel and the thumb pad such that the thumb pad can be floated and located at any place over the touch panel (e.g., top right or left corners, bottom right or left corners, etc.) as desired or necessitated by the user while maintaining the functionality and operability of the thumb pad. Finally, a user interface module 210 works with the hardware extension 110 to provide the user a user interface to conveniently work the thumb pad in accordance with its intended purpose.

It is contemplated that any number and type of components may be added to and removed from the TP thumb pad mechanism 108 to facilitate the workings and operability of the thumb sensor. For brevity, clarity, ease of understanding and to focus on the TP thumb pad mechanism 108, many of the default or known components of a computing device are not shown or discussed here. For example, the display of the computing device may be continuously (re-) adjusted or (re-)align based on the changing information being communicated by user inputs via the thumb pad.

FIGS. 3A-3C illustrate a computing device employing and facilitating a thumb pad using a TP thumb pad mechanism according to one embodiment of the invention. FIG. 3A illustrates the computer system 100 (e.g., a mobile computing device, such as a smartphone) having a touch panel 302 and a novel thumb pad 304 transparently overlaying in the upper right corner of the touch panel 302. As aforementioned, in one embodiment, the thumb pad 304 may be moveable and can be moved around the touch pad 302 by the user by touching and holding the thumb pad 304 and placing it anywhere (e.g., upper left corner, lower right corner, etc.) on the touch pad 302.

FIG. 3B illustrates an embodiment of the thumb pad 304 illustrating is various movements. For example, in one embodiment, the user may place his or her thumb or finger to move the thumb pad 304 in various directions 316, such as up, down, left, right, circular, etc. Now referring to FIG. 3C, it illustrates the computing device 100 having a thumb pad capacitive column 306 to employ and facilitate the thumb pad 304 with the touch panel 302. In one embodiment, the illustrated capacitive column 306 may refer to a side column where the thumb pad 304 is situated, such as the right most column or the column to the right of the thumb pad 304 as illustrated here (or, for example, the left column if the thumb pad 304 occupied the left side of the device, and the like), may be electrically driven with a higher and more sensitivity charge, such as to sense the thumb that is off the panel to the right side (e.g., similar to a “hover” detection, etc., such as a non-uniform capacitive charge that is used in the thumb pad 304 to detect extreme edge interactions. Further, in one embodiment, the capacitive column 306 provided by the thumb pad capacitive lines may be lighter, but probably not less sensitive, than the normal capacitive charge provided on the edge of the touch panel by the touch panel capacitive lines. In one embodiment, the thumb pad interaction may be implemented directly using the touch panel hardware, such as without having to employ separate or additional hardware to employ the thumb pad 304, by using non-uniformed sensitivity across the touch panel 302 and increasing the column sensitivity (e.g., top corner right column sensitivity) for managing the touch-on-edge interaction (e.g., thumb-on-edge interaction, sensor-on-edge interaction, etc.). In one embodiment, and as aforementioned, any user transaction using the thumb pad 306 be analyzed and interpreted and then reflected as an action (e.g., a new set of information, such as a new website, is displayed on the screen, the screen is scrolled up and/or down, an error message is displayed, etc.) being displayed by and on a display screen (e.g., the touch panel 302) of the computing device 100.

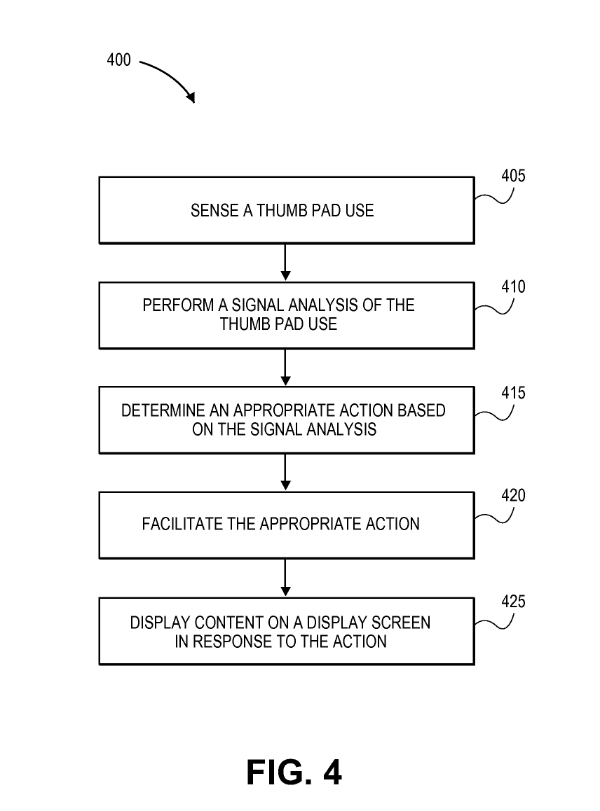

FIG. 4 illustrates a method for employing and facilitating a thumb pad using a TP thumb pad mechanism according to one embodiment of the invention. Method 400 may be performed by processing logic that may comprise hardware (e.g., circuitry, dedicated logic, programmable logic, etc.), software (such as instructions run on a processing device), or a combination thereof. In one embodiment, method 400 may be performed by the TP thumb pad mechanism of FIG. 1.

Method 400 starts at processing block 405 with sensing of a use of a thumb pad of a computing device (e.g., a mobile computing device, such as a smartphone, a tablet computer, an e-reader, etc.). The thumb pad may be placed over within a specified space (e.g., top right corner) of a touch panel of the computing device. In other words, in one embodiment, each time a user touches (or presses or rolls or flicks, etc.) the thumb pad, the thumb pad use is sensed by detecting the relevant intersecting points formed by thumb pad capacitive lines and the touch panel capacitive lines. At block 410, a signal analysis of the thumb sensor use is performed to interpret the thumb pad use, such as to determine the intended purpose of the use of the thumb pad, such as whether the use was accidental and, if not, whether the thumb sensor was pressed or rolled or scrolled or flicked, etc., in a given direction so that the intended purpose of the use can be accurately determined. At block 415, based on the signal analysis and interpretation of the use, an appropriate action is determined. At block 420, the appropriate action is facilitated by the action facilitator. At block 425, in response to the facilitation of the appropriate action, the display screen (e.g., touch panel) of the computing device displays the appropriate content (e.g., a website).

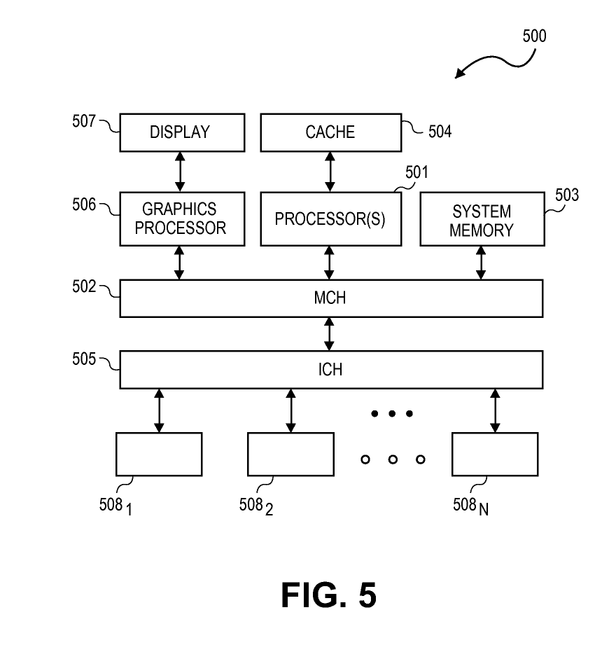

FIG. 5 illustrates a computing system 500 employing and facilitating a thumb pad as referenced throughout this document according to one embodiment of the invention. The exemplary computing system 500 may be the same as or similar to the computing device 100 of FIG. 1 and include: 1) one or more processors 501 at least one of which may include features described above; 2) a memory control hub (MCH) 502; 3) a system memory 503 (of which different types exist such as double data rate RAM (DDR RAM), extended data output RAM (EDO RAM) etc.); 4) a cache 504; 5) an input/output (I/O) control hub (ICH) 505; 6) a graphics processor 506; 7) a display/screen 507 (of which different types exist such as Cathode Ray Tube (CRT), Thin Film Transistor (TFT), Light Emitting Diode (LED), Molecular Organic LED (MOLED), Liquid Crystal Display (LCD), Digital Light Projector (DLP), etc.; and 8) one or more I/O devices 508.

The one or more processors 501 execute instructions in order to perform whatever software routines the computing system implements. The instructions frequently involve some sort of operation performed upon data. Both data and instructions are stored in system memory 503 and cache 504. Cache 504 is typically designed to have shorter latency times than system memory 503. For example, cache 504 might be integrated onto the same silicon chip(s) as the processor(s) and/or constructed with faster static RAM (SRAM) cells whilst system memory 503 might be constructed with slower dynamic RAM (DRAM) cells. By tending to store more frequently used instructions and data in the cache 504 as opposed to the system memory 503, the overall performance efficiency of the computing system improves.

System memory 503 is deliberately made available to other components within the computing system. For example, the data received from various interfaces to the computing system (e.g., keyboard and mouse, printer port, Local Area Network (LAN) port, modem port, etc.) or retrieved from an internal storage element of the computer system (e.g., hard disk drive) are often temporarily queued into system memory 503 prior to their being operated upon by the one or more processor(s) 501 in the implementation of a software program. Similarly, data that a software program determines should be sent from the computing system to an outside entity through one of the computing system interfaces, or stored into an internal storage element, is often temporarily queued in system memory 503 prior to its being transmitted or stored.

The ICH 505 is responsible for ensuring that such data is properly passed between the system memory 503 and its appropriate corresponding computing system interface (and internal storage device if the computing system is so designed). The MCH 502 is responsible for managing the various contending requests for system memory 503 accesses amongst the processor(s) 501, interfaces and internal storage elements that may proximately arise in time with respect to one another. In one embodiment, the MCH 502 and ICH 505 may not be separately employed; but rather, be provided as part of a chipset that includes the MCH 502, ICH 505, other controller hubs, and the like.

One or more I/O devices 508 are also implemented in a typical computing system. I/O devices generally are responsible for transferring data to and/or from the computing system (e.g., a networking adapter); or, for large scale non-volatile storage within the computing system (e.g., hard disk drive). ICH 505 has bi-directional point-to-point links between itself and the observed I/O devices 508.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer -readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

In the foregoing specification, the invention has been described with reference to specific exemplary embodiments thereof. It will, however, be evident that various modifications and changes may be made thereto without departing from the broader spirit and scope of the invention as set forth in the appended claims. The Specification and drawings are, accordingly, to be regarded in an illustrative rather than a restrictive sense.

1. A computer-implemented method comprising:
sensing a use of a sensor pad transparently placed over and within a dedicated section of a touch panel of a computing device, wherein the sensor pad and its relevant sensor pad interaction are employed using hardware of the touch panel, the use comprising touching of the sensor pad by a user, and wherein sensing comprises detecting a change at one or more intersecting points of a plurality of intersecting points; and
facilitating an action in response to the use of the sensor pad.

2. The computer-implemented method of claim 1, wherein the hardware of the touch panel is used to employ the relevant sensor pad interaction by triggering a non-uniform sensitivity across the touch panel, wherein triggering comprises increasing sensitivity of a corresponding column for managing a touch-on-edge interaction of the sensor pad interaction, wherein the corresponding column refers to a column or section of the touch panel where the sensor pad is employed.

3. The computer-implemented method of claim 1, wherein sensing further comprises receiving a message relating to the use of the sensor pad from the one or more intersecting points of the plurality of intersecting points providing by conductive lines of the touch panel.

4. The computer-implemented method of claim 1, wherein the dedicated section comprises one or more corners of the touch panel, wherein the dedicated section comprises a triangular section of the touch panel to accommodate the sensor pad.

5. The computer-implemented method of claim 1, wherein analyzing comprises interpreting the sensed use to determine an intended purpose of the use as intended by the user of the sensor pad to determine an action in response to the use and in accordance with the intended purpose.

6. The computer-implemented method of claim 1, wherein the sensor pad comprises a thumb pad that is operable by a user touch facilitated by a thumb or a finger of the user.

7. The computer-implemented method of claim 1, wherein the computing device comprises a mobile computing device comprising one or more of a smartphone, a handheld computing device, a tablet computing device, and e-reader.

8. A system comprising:
a host computing device having a memory to store instructions for facilitating a thumb sensor pad mechanism, and a processing device to execute the instructions, wherein the instructions cause the processing device to:
sense a use of a sensor pad transparently placed over and within a dedicated section of a touch panel of a computing device, wherein the sensor pad and its relevant sensor pad interaction are employed using hardware of the touch panel, the use comprising touching of the sensor pad by a user, and wherein sensing comprises detecting a change at one or more intersecting points of a plurality of intersecting points; and
facilitate an action in response to the use of the sensor pad.

9. The system of claim 8, wherein the hardware of the touch panel is used to employ the relevant sensor pad interaction by triggering a non-uniform sensitivity across the touch panel, wherein triggering comprises increasing sensitivity of a corresponding column for managing a touch-on-edge interaction of the sensor pad interaction, wherein the corresponding column refers to a column or section of the touch panel where the sensor pad is employed.

10. The system of claim 8, wherein sensing further comprises receiving a message relating to the use of the sensor pad from the one or more intersecting points of the plurality of intersecting points providing by conductive lines of the touch panel.

11. The system of claim 8, wherein the dedicated section comprises one or more corners of the touch panel, wherein the dedicated section comprises a triangular section of the touch panel to accommodate the sensor pad.

12. The system of claim 8, wherein analyzing comprises interpreting the sensed use to determine an intended purpose of the use as intended by the user of the sensor pad to determine an action in response to the use and in accordance with the intended purpose.

13. The system of claim 8, wherein the sensor pad comprises a thumb pad that is operable by a user touch facilitated by a thumb or a finger of the user.

14. The system of claim 8, wherein the computing device comprises a mobile computing device comprising one or more of a smartphone, a handheld computing device, a tablet computing device, and e-reader.

15. A machine-readable medium comprising instructions that, when executed by a machine, cause the machine to:
sense a use of a sensor pad transparently placed over and within a dedicated section of a touch panel of a computing device, wherein the sensor pad and its relevant sensor pad interaction are employed using hardware of the touch panel, the use comprising touching of the sensor pad by a user, and wherein sensing comprises detecting a change at one or more intersecting points of a plurality of intersecting points; and
facilitate an action in response to the use of the sensor pad.

16. The machine-readable medium of claim 15, wherein the hardware of the touch panel is used to employ the relevant sensor pad interaction by triggering a non-uniform sensitivity across the touch panel, wherein triggering comprises increasing sensitivity of a corresponding column for managing a touch-on-edge interaction of the sensor pad interaction, wherein the corresponding column refers to a column or section of the touch panel where the sensor pad is employed.

17. The machine-readable medium of claim 15, wherein sensing further comprises receiving a message relating to the use of the sensor pad from the one or more intersecting points of the plurality of intersecting points providing by conductive lines of the touch panel.

18. The machine-readable medium of claim 15, wherein the dedicated section comprises one or more corners of the touch panel, wherein the dedicated section comprises a triangular section of the touch panel to accommodate the sensor pad.

19. The machine-readable medium of claim 15, wherein analyzing comprises interpreting the sensed use to determine an intended purpose of the use as intended by the user of the sensor pad to determine an action in response to the use and in accordance with the intended purpose.

20. The machine-readable medium of claim 15, wherein the sensor pad comprises a thumb pad that is operable by a user touch facilitated by a thumb or a finger of the user.
